(19) United States
(12) Patent Application Publication
(10) Pub. No.: US 2023/0303386 A1
(43) Pub. Date: Sep. 28, 2023

(54) BRIDLE FOR RIDING HORSES

(71) Applicant: JOH'S. STUEBBEN GMBH & CO. KG, Krefeld (DE)

(72) Inventors: Oda Krumey, Kempen (DE); Helena Grintzalis, Kempen (DE); Johannes Stuebben, Kempen (DE)

(21) Appl. No.: 18/124,956

(22) Filed: Mar. 22, 2023

(30) Foreign Application Priority Data
Mar. 23, 2022 (EP) 22163768.9

(51) Int. Cl. B68B 5/00

(52) U.S. Cl. CPC B68B 5/00

(57) ABSTRACT

The invention relates to a bridle (1) for riding horses, having a head harness (3) formed by a plurality of straps (2), having a bit (4) releasably connected to the head harness (3), and having at least one quick fastener (5) for connecting a strap (2) to a further component (2′, 4, 20) of the bridle (1), wherein the quick fastener (5) has two fastener components (6, 7) which are movable linearly with respect to one another in order to mechanically secure and release the quick fastener (5).

The invention relates to a bridle for riding horses and to a quick fastener for a bridle for riding horses. Furthermore, a method for replacing a bit on a bridle for riding horses and the use of at least one quick fastener for fastening a bit to a bridle for riding horses are specified.

A bridle for a horse usually consists of a head harness for the animal’s head, which is constructed from straps, and of reins or lines. A bridle is used to direct and guide a horse. A distinction is drawn between a bitless bridle and a bridle in which a bit, preferably made of metal, is used. Bridles can also be used as a halter for tethering and guiding the horse.

The material used for the straps is normally abrasion-resistant leather, which can take up moisture and release it again. Recently, use has also been made of synthetic materials as a leather replacement, since these may be easier to clean.

The head harness of a bridle for a horse usually contains a crownpiece and a browband. When a bridle is fitted on a horse, the crownpiece extends over the horse’s poll, directly behind the ears as seen from the front, while the browband extends directly in front of the ears over the horse’s brow and fixes the crownpiece. The browband is fastened to the crownpiece. It is sometimes also referred to as a dressage browband, since it is readily visible on the front of the horse and offers both the manufacturer of the bridle and the rider options with regard to the design of the bridle. The crownpiece normally carries the weight of the bridle.

In particular in professional equestrian sport, it may be necessary to frequently change or replace the bits of the bridles. Thus, a rider may have for example different bits for the same head harness, which each serve different purposes and/or have different properties. Furthermore, for cleaning the bits, it may be advantageous to detach them from the straps of the bridle beforehand. In order for it to be possible to replace the bits, these are generally fastened via two rings to two loops, which are formed by means of the free ends of two straps of the head harness. In the prior art, the free ends are connected to the respective straps by means of buckle connections in order to form the loops.

However, experience has shown that, in practice, the opening and closing of corresponding buckle connections can take some time, in particular because the relevant buckles are generally relatively small and can therefore be difficult to open and close for many people. Furthermore, corresponding buckle connections generally require the threading of the free end of the relevant strap into the buckle, wherein the strap is usually bent about relatively small radii. This can result in increased wear of the straps.

Against this background, it is an object of the present invention to at least partially solve the problems outlined in relation to the prior art. In particular, a bridle for riding horses is intended to be specified, which makes it possible to replace the bit as easily and/or quickly as possible. Furthermore, the bridle should preferably be as robust and/or durable as possible.

These objects are achieved by the features of the independent claims. Further advantageous configurations of the solution proposed here are specified in the dependent claims. It should be noted that the features listed individually in the dependent claims can be combined with one another in any desired, technically meaningful way and define further configurations of the invention. Furthermore, the features specified in the claims are described and explained in more detail in the description, wherein further preferred configurations of the invention are presented.

A bridle for riding horses contributes to this, having a head harness formed by a plurality of straps, having a bit releasably connected to the head harness, and having at least one quick fastener for connecting a strap to a further component of the bridle, wherein the quick fastener has two fastener components which are movable linearly with respect to one another in order to mechanically secure and release the quick fastener.

The bridle may preferably comprise at least two corresponding quick fasteners. These may be arranged in order to fasten the bit to the head harness. For example, the quick fasteners may be assigned to those straps of the head harness that are provided and designed for fastening the bit.

For example, the two fastener components may be movable linearly with respect to one another along a defined opening direction and/or a defined closing direction and/or along a defined axis. The opening direction and the closing direction are generally opposite to one another. The opening direction and the closing direction, or the defined axis may be defined for example by an appropriate design of the fastener components. For example, an internal shape of the second fastener component may be adapted to an external shape of the first fastener component, in particular such that the second fastener component is able to be guided linearly by the first fastener component.

The two fastener components may be connectable to the bridle for example separately from one another. In particular, the two fastener components are not connected directly together. In particular, the quick fastener does not have an element that is rotatable about a transverse axis, in particular does not have a peg or hook (in particular a so-called panic snap) that is pivotable about a transverse axis of the quick fastener.

The quick fastener is provided and designed for the advantageously secure connection of a strap to a further component of the bridle. The further component may advantageously be a bit or an element of a bit, such as a ring of the bit for instance. Alternatively or in addition, the further component may be a further strap of the bridle or head harness. Furthermore, alternatively or in addition, the further component may be a rein of the bridle.

According to an advantageous configuration, it is proposed that the quick fastener is arranged in an end region of one of the straps, in order to secure a loop, formed by the end region of the strap, for the bit. A ring of the bit, to which it is also possible for example for an end of a rein to be attached, can be held or guided in the loop. In this connection, it is also possible for two loops to be secured by respective quick fasteners in order for it to be possible to connect the bit to the head harness as quickly and easily as possible on both sides.

According to a further advantageous configuration, it is proposed that a first fastener component of the two fastener components is fixedly connected to one of the straps. A riveted connection may advantageously contribute to this. This may be realized in principle via a separate rivet and/or by using a peg of the first fastener component.

According to a further advantageous configuration, it is proposed that the first fastener component has a peg onto which a hole in a free end of a strap can be fitted. In particular, the free end of the strap can be fitted onto the peg in order to form the loop, which can advantageously be used to fasten a bit.

The first fastener component may have for example a preferably plate-like base. The base may have a rectangular shape (as seen from above or below). In particular, the base may have a substantially rectangular top side and underside. Preferably, two straight, mutually opposite outer edges of the base can advantageously contribute to the linear guidance of the in particular sleeve-like second fastener component.

The peg may extend starting from the base and (upwardly) away from the latter. The peg may (in the process) extend through the material of the strap. The base may bear against an underside of the strap. Placed on a top side of the strap may be a washer, which can be guided over the peg. This may advantageously contribute to fastening the first fastener component to the strap, in particular in the manner of a riveted connection.

According to a further advantageous configuration, it is proposed that a second fastener component of the two fastener components is arranged so as to be longitudinally movable on one of the straps. In particular, the second fastener component of the two fastener components may be arranged so as to be longitudinally movable on the same strap.

For example, the second fastener component may be in the form of a sleeve through which at least one of the straps or the strap can extend (once or multiple times). For example, the sleeve may be formed such that two straps can extend parallel to one another at least in portions through the sleeve. The sleeve may be formed such that two portions of one of the straps or of the strap can extend at least partially parallel to one another through the sleeve.

According to a further advantageously configuration, it is proposed that at least one of the two fastener components has a locking means in order to at least partially block a linear relative movement of the two fastener components. This may advantageously contribute to the second fastener component being able to be retained as captively as possible on the bridle.

Here, a first of the locking means may be formed by a first recess in an inner surface of the second fastener components, wherein the recess is designed and arranged such that a tip of the peg engages in the recess in the closed state of the quick fastener. The first recess may be arranged in particular in an upper and in particular inwardly and/or downwardly facing inner surface of the second fastener component.

Furthermore, a second of the fastener means may be formed by a second recess in an outer surface of the first fastener component. The second recess may be arranged in particular in a lower and in particular outwardly and/or downwardly facing outer surface of the second fastener component. The second recess may possibly be formed by means of a bore, in particular a through-bore.

In particular, a third of the locking means may be formed by a protrusion on an inner surface of the second fastener component, wherein the protrusion is designed and arranged such that it engages in the second recess in the closed state of the quick fastener. The protrusion may be arranged in particular on a lower and in particular inwardly and/or upwardly facing inner surface of the second fastener component.

Furthermore, a fourth locking means may be formed by a latching shoulder on the first fastener component, wherein the latching shoulder is designed and arranged such that it blocks a further linear movement of the second fastener component in a closing direction in the closed state of the quick fastener. The latching shoulder may extend for example transversely to the direction of linear movement.

The quick fastener or the two fastener components may be made for example of metal. In particular, the quick fastener may be coated at least partially or entirely by means of a PVD coating. PVD coatings can be produced in different colors and thus contribute advantageously to the design of bridles. Furthermore, PVD coatings can also contribute to the robustness or durability of the surfaces of components.

According to a further aspect, a quick fastener for a bridle for riding horses is specified, wherein the quick fastener has two fastener components which are movable linearly with respect to one another in order to mechanically secure and release the quick fastener.

According to a further aspect, a method for replacing a bit on a bridle for riding horses is specified, comprising at least the following steps:
a) releasing at least one quick fastener, to which end two fastener components of the quick fastener are moved linearly with respect to one another in order to free a loop formed by an end region of a strap of the bridle,
b) connecting a bit to the bridle by closing the loop,
c) securing the quick fastener, to which end the two fastener components are moved linearly with respect to one another in order to secure the loop.

In particular, the bit on a bridle described herein can be replaced. Steps a), b) and c) can be carried out for example at least once and/or repeatedly in the specified order to carry out the method. Furthermore, steps a), b) and c), in particular steps a) and b) or b) and c) can be carried at least partially in parallel or at the same time.

According to a further aspect, the use of at least one quick fastener for fastening a bit to a bridle for riding horses is specified, wherein the quick fastener has two fastener components which are movable linearly with respect to one another in order to mechanically secure and release the quick fastener.

The details, features and advantageous configurations mentioned in relation to the bridle can also arise correspondingly in the quick fastener, the method and/or the use presented here, and vice versa. In this regard, reference is made in full to the statements made there in order to characterize the features in more detail.

The use of the indefinite article (“a” and “an”), in particular in the claims and the description reproducing the latter, should be understood as such and not as a numeral (“one”). Accordingly, terms and components introduced thereby should be understood as meaning that they are present at least once, but in particular may also be present multiple times.

As a precaution, it is pointed out that the numerals (“first”, “second”, “third”, “fourth” etc.) used herein serve primarily (only) to differentiate several articles, sizes or processes of the same type, i.e. in particular do not necessarily imply any dependency and/or order of these articles, sizes or processes with respect to one another. Should a dependency and/or order be required, this is explicitly stated here and will be obvious to a person skilled in the art on studying the specifically described configuration. If a component can be present multiple times (“at least one”), the description for one of these components may apply equally to all or some of the plurality of these components, but this is not absolutely necessary.

The solution presented here and the technical environment thereof are explained in more detail in the following text with reference to the figures. It should be noted that the invention is not intended to be limited to the exemplary embodiments shown. In particular, unless explicitly stated otherwise, it is also possible for partial aspects of the substantive matter explained in the figures to be extracted and combined with other constituent parts and/or insights from other figures and/or the present description. In the figures, schematically:

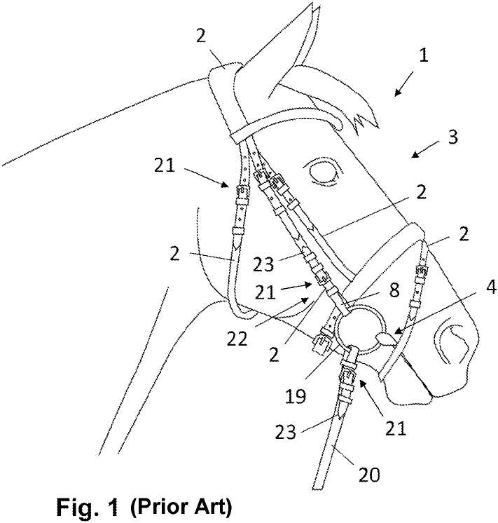

FIG. 1: shows a perspective illustration of an example of a bridle 1 for riding horses from the prior art,

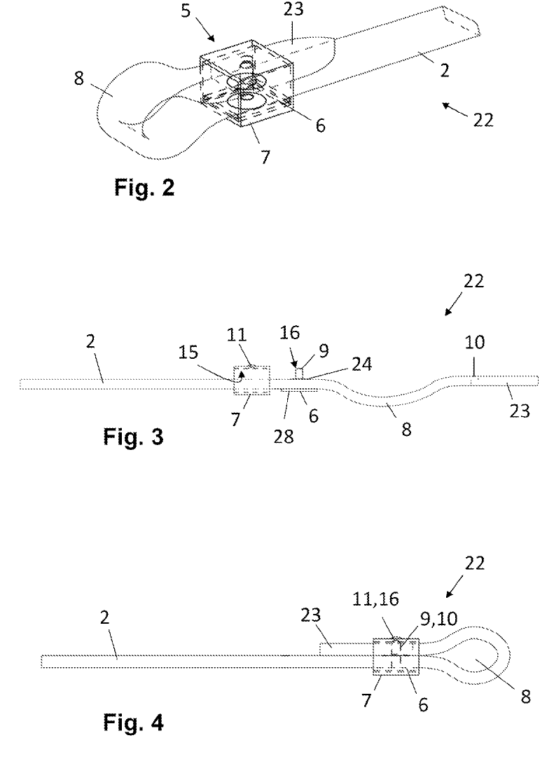

FIG. 2: shows a perspective illustration of an example of a quick fastener as proposed herein,

FIG. 3: shows a side view of the example from FIG. 2 in an open state,

FIG. 4: shows a side view of the example from FIG. 2 in a closed state,

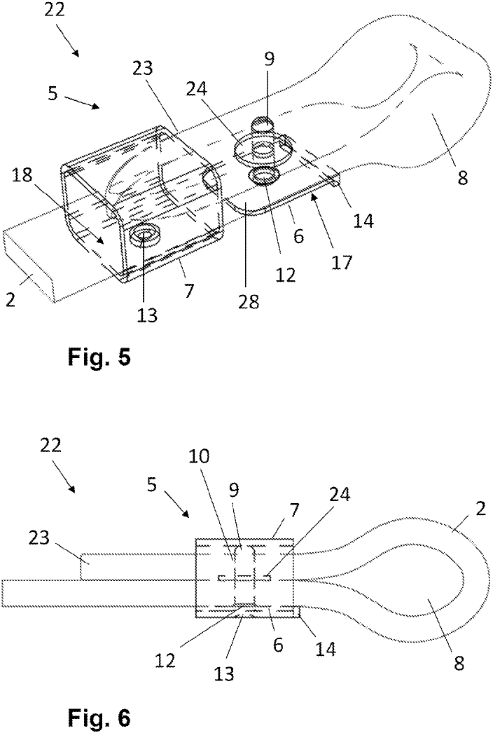

FIG. 5: shows a perspective illustration of a further example of a quick fastener as proposed herein,

FIG. 6: shows a side view of the example from FIG. 5 in a closed state,

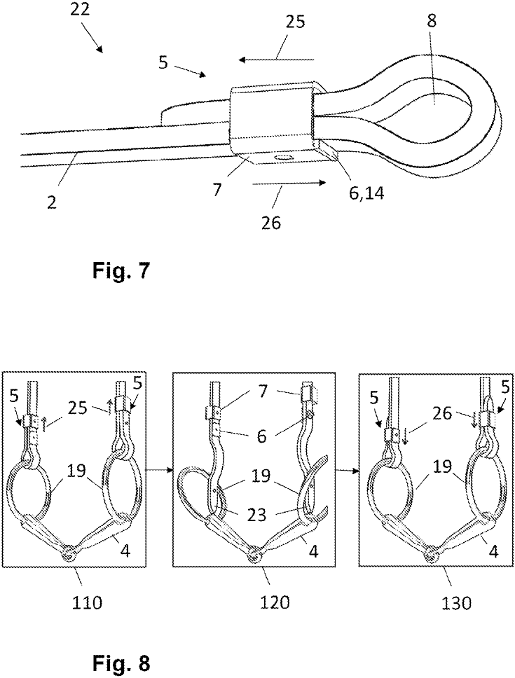

FIG. 7: shows a perspective illustration of a demonstration of the operation of the example from FIG. 5,

FIG. 8: shows an example of a sequence of a method as presented herein,

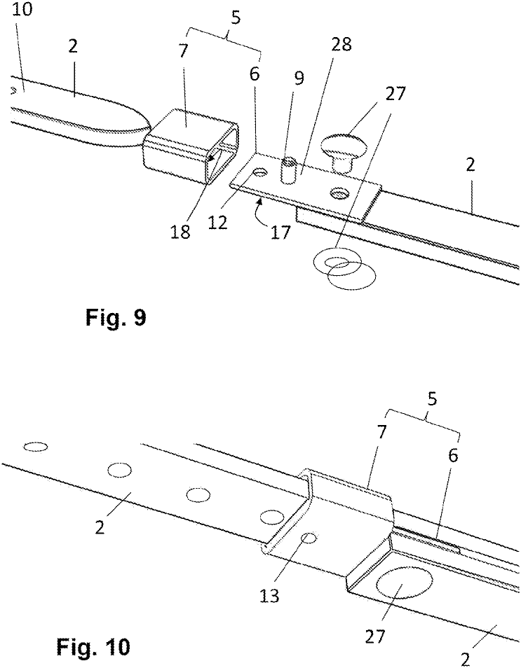

FIG. 9: shows a perspective illustration of a further example of a quick fastener as proposed herein in an open state,

FIG. 10: shows a perspective illustration of the example from FIG. 9 in a closed state, and

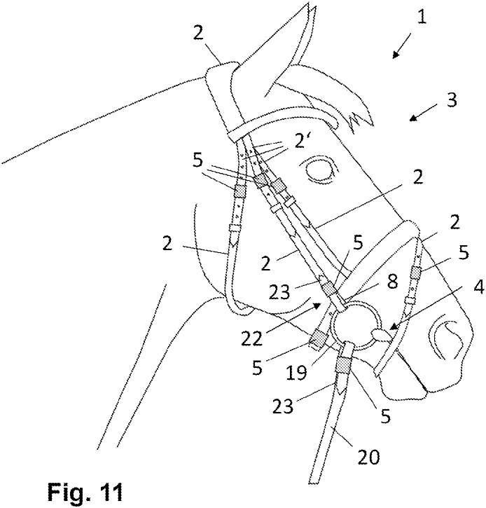

FIG. 11: shows examples of possible uses of the quick fastener described herein on a bridle.

FIG. 1 schematically shows an example of a bridle 1 for riding horses from the prior art. The bridle 1 has a plurality of straps 2, which form a head harness 3. Via two of the straps 2, of which only one can be seen in the illustration according to FIG. 1 since the other strap 2 is located on the opposite side of the horse’s head, the head harness 3 is connected releasably to a bit 4. To this end, two rings 19 of the bit 4 are accordingly held or guided in respective loops 8, which are formed by means of end regions 22 of the two straps 2 of the head harness 3. Furthermore, the reins 20 for directing the horse can also be attached to the rings 19.

In the prior art, the free ends 23 of the straps 2 for fastening the bit 4 are connected to the relevant strap 2 itself by means of buckles 21 in order to form the loops 8. However, it may be difficult to open and close corresponding buckles 21. In addition, corresponding buckles 21 generally contribute to increased wear of the straps 2. The abovementioned drawbacks can advantageously be solved by the invention described in the following text.

FIG. 2 schematically shows an example of a quick fastener 5, as proposed herein, for a bridle 1 for riding horses (cf. FIG. 1.). The quick fastener 5 has two fastener components 6, 7, which are movable linearly with respect to one another in order to mechanically secure and release the quick fastener 5.

FIG. 3 schematically shows the example from FIG. 2 in an open state. FIG. 4 schematically shows the example from FIG. 2 in a closed state.

FIGS. 2, 3 and 4 illustrate for example that, and possibly how, the quick fastener 5 can be arranged in an end region 22 of one of the straps 2 in order to secure a loop 8, formed by the end region 22 of the strap 2, for the bit 4. Preferred positions of a strap 2 that is relevant here and in particular of the end region 22 on the bridle 1 are illustrated by way of example in FIG. 1.

In particular a first fastener component 6 of the two fastener components 6, 7 is fixedly connected to one of the straps 2 or the strap 2. The first fastener component 6 has in this case for example a peg 9. The peg 9 may pass through the strap 2 in the manner of a riveted connection. A washer 24 may contribute to securing the connection. It is possible for example for a hole 10 in a free end of the strap 2 to be fitted onto the peg 9, in particular to form the loop 8.

A second fastener component 7 of the two fastener components 6, 7 may preferably arranged so as to be longitudinally movable on one of the straps 2. In this connection, the second fastener component 7 may preferably be in the form of a sleeve through which at least one of the straps 2 can extend. As illustrated here, the sleeve may have a rectangular cross-sectional shape. However, a rounded or rounder cross-sectional shape would also be conceivable in principle.

The first fastener component 6 may have an in particular plate-like base 28. Starting from the base 28, it is possible for example for the peg 9 to extend upward. The shape of the base 28 may be adapted for example to the shape of the sleeve of the second fastener component 7 such that the sleeve is able to be guided by the base 28.

Furthermore, at least one of the two fastener components 6, 7 may have a locking means 11, 12, 13, 14 in order to at least partially block a linear relative movement of the two fastener components 6, 7.

FIGS. 2, 3 and 4 show an example of a first of the locking means 11, 12, 13, 14, which is formed by a first recess 11 in an inner surface 15 of the second fastener component 7. The recess 11 is designed and arranged such that a tip 16 of the peg 9 engages in the recess 11 in the closed state of the quick fastener 5 (see in particular the illustration according to FIG. 4).

FIG. 5 schematically shows a further example of a quick fastener 5 as proposed herein. FIG. 6 schematically shows the example from FIG. 5 in a closed state. The reference signs are used consistently, and so reference may be made to the above explanations.

The example according to FIG. 5 shows for example that, and possibly how, a second of the fastener means 11, 12, 13, 14 can be formed by a second recess 12 in an outer surface 17 of the first fastener component 6. Also illustrated for example is that, and possibly how, a third of the locking means 11, 12, 13, 14 may be formed by a protrusion 13 on an inner surface 18 of the second fastener component 7, wherein the protrusion 13 is designed and arranged such that it engages in the second recess 12 in the closed state of the quick fastener 5.

FIG. 5 also shows for example that, and possibly how, a fourth of the locking means 11, 12, 13, 14 may be formed by a latching shoulder 14 on the first fastener component 6, wherein the latching shoulder 14 is designed and arranged such that it blocks a further linear movement of the second fastener component 7 in a closing direction in the closed state of the quick fastener 5.

As a precaution, it is pointed out once again at this point that the numerals (“first”, “second”, “third”, “fourth” etc.) used herein serve primarily (only) to differentiate several articles, in this case possible locking means, i.e. in particular do not necessarily imply any dependency and/or order of these articles with respect to one another. For example a locking means described here as “fourth” can also be provided regardless of whether a first, second or third locking means is present.

In principle, individual ones or a plurality of the different locking means 11, 12, 13, 14 can be used in different possible combinations with one another or independently of one another, in particular individually or alone. Preferably, for example the second locking means 12 and the third locking means 13 are used in combination with one another. By contrast, it is possible for example for the first locking means 11 and the fourth locking means 14 also to be used in principle individually or alone.

FIG. 7 schematically shows a perspective illustration of a demonstration of the operation of the example from FIG. 5. An opening direction 25 and a closing direction 26 are indicated for example in FIG. 7, along which the fastener components 6, 7 can be moved linearly with respect to one another in order to mechanically secure and release the quick fastener 5. It is apparent from the perspective view in FIG. 7 that, and possibly how, the fourth locking means 14, i.e. the latching shoulder 14, can be designed and arranged such that it can block a further linear movement of the second fastener component 7 in the closing direction 26 in the closed state of the quick fastener 5.

FIG. 8 schematically shows an example of a sequence of a method as presented herein. The method serves to replace a bit 4 on a bridle 1 for riding horses. The order, illustrated by the blocks 110, 120 and 130, of the steps a), b) and c) is by way of example and can be run through at least once in the indicated order in order to carry out the method.

In block 110, according to step a), at least one quick fastener 5 is released, to which end two fastener components 6, 7 of the quick fastener 5 are moved linearly with respect to one another in order to free a loop 8 formed by an end region of a strap 2 of the bridle 1. In block 120, according to step b), a bit 4 is connected to the bridle 1 by closing the loop 8. In block 130, according to step c), the quick fastener 5 is secured, to which end the two fastener components 6, 7 are moved linearly with respect to one another in order to secure the loop 8.

The method can be used in order to replace the bit 4 on a bridle 1 that is also described here.

FIG. 8 also illustrates an example of the use of at least one quick fastener 5 for fastening a bit 4 to a bridle 1 for riding horses, wherein the quick fastener 5 has two fastener components 6, 7 which are movable linearly with respect to one another in order to mechanically secure and release the quick fastener 5.

FIG. 9 schematically shows a further example of a quick fastener 5 as proposed herein in an open state. FIG. 10 schematically shows the example from FIG. 9 in a closed state. The reference signs are used consistently, and so reference may be made to the above explanations.

In the examples illustrated in FIGS. 2 to 8, the quick fasteners 5 each serve to fasten a bit 4 to a head harness 3 of a bridle 1 by means of a respective loop 8, which is formed in each case by an end region 22 of an individual strap 2 and is secured by means of the respective quick fastener 5. By contrast, the quick fastener 5 in the example illustrated in FIGS. 9 and 10 serves in particular to connect two straps 2 together, in particular to connect a strap 2 to a different, further strap 2′ of the bridle 1 or head harness 3.

In this connection, a further example shows that and how the first fastener component 6 of the two fastener components 6, 7 can be connected fixedly to one of the straps 2. For example, to this end, the first fastener component 6 is connected fixedly to the right-hand strap 2 by means of a rivet 27 provided in addition to the peg 9.

In the example shown in FIGS. 9 and 10, further possible embodiment variants of the second locking means 12 and of the third locking means 13 are shown, which are used in combination with one another here too.

In the examples illustrated in FIGS. 2 to 8, the sleeve shape of the second fastener component 7 is dimensioned for example such that two portions of the same strap 2 can be guided one on top of the other through the sleeve. The example shown in FIGS. 9 and 10 illustrates that and how the sleeve shape of the second fastener component 7 can be embodied in a flatter manner. Allowing the base 28 of the first fastener component 6 to project beyond one end of a strap 2, for example, may contribute to this.

The embodiment, illustrated for example by the embodiment variant according to FIGS. 9 and 10, of a strap connection of a strap 2 to a further strap 2′ may in principle also be used independently of the other embodiment variants illustrated herein (which all relate to a bridle 2) for connecting two straps 2, 2′ together, and may also independently or as such form a subject of the invention that is worthy of protection. The strap connection has in this case at least one quick fastener 5 as described herein for connecting one strap 2 to the further strap 2′, wherein the quick fastener 5 has two fastener components 6, 7 which are movable linearly with respect to one another in order to mechanically secure and release the quick fastener 5.

The strap connection may be used in particular to connect two leather straps 2, 2′ together or be provided and designed therefor.

The details, features and advantageous configurations mentioned in relation to the bridle 1 can also arise correspondingly in the strap connection presented here, and vice versa. In this regard, reference is made in full to the statements made there in order to characterize the features in more detail.

FIG. 11 schematically shows examples of possible uses of the quick fastener 5 described herein on a bridle 1. In particular, a large number of different possible uses of the quick fastener 5 on the bridle 1 are illustrated here, of which only individual ones or a plurality may be used. In particular, it is not necessary for all the possible uses illustrated here by way of example to be realized on a bridle 1.

Particularly preferably, the quick fastener 5 is used for the as far as possible easily releasable and reclosable connection between a strap 2, also referred to as jaw piece, and the ring 19 of the bit 4. Also advantageously, the quick fastener 5 may be used for the as far as possible easily releasable and reclosable connection between the rein 20 and the ring 19 of the bit 4.

Furthermore, FIG. 11 also illustrates by way of example that and possibly how the quick fastener 5 can be used for connecting two straps 2, in particular for connecting a strap 2 to a different, further strap 2′ of the bridle 1 or head harness 3.

Thus, a bridle 1 for riding horses can be specified, which makes it possible to replace the bit 4 as easily and/or quickly as possible. Furthermore, the bridle 1 can preferably be as robust and/or durable as possible.

List of reference signs

| | |
|---|---|
| 1 | Bridle |
| 2 | Strap |
| 2′ | Further strap |
| 3 | Head harness |
| 4 | Bit |
| 5 | Quick fastener |
| 6 | First fastener component |
| 7 | Second fastener component |
| 8 | Loop |
| 9 | Peg |
| 10 | Hole |
| 11 | Locking means, first recess |
| 12 | Locking means, second recess |
| 13 | Locking means, protrusion |
| 14 | Locking means, latching shoulder |
| 15 | Inner surface |
| 16 | Tip |
| 17 | Outer surface |
| 18 | Inner surface |
| 19 | Ring |
| 20 | Rein |
| 21 | Buckle |
| 22 | End region |
| 23 | End |
| 24 | Washer |
| 25 | Opening direction |
| 26 | Closing direction |
| 27 | Rivet |
| 28 | Base |

1. A bridle (1) for riding horses, having a head harness (3) formed by a plurality of straps (2), having a bit (4) releasably connected to the head harness (3), and having at least one quick fastener (5) for connecting a strap (2) to a further component (2′, 4, 20) of the bridle (1), wherein the quick fastener (5) has two fastener components (6, 7) which are movable linearly with respect to one another in order to mechanically secure and release the quick fastener (5).

2. The bridle (1) as claimed in claim 1, wherein the quick fastener (5) is arranged in an end region (22) of one of the straps (2), in order to secure a loop (8), formed by the end region (22) of the strap (2), for the bit (4).

3. The bridle (1) as claimed in claim 1,wherein a first fastener component (6) of the two fastener components (6, 7) is fixedly connected to one of the straps (2).

4. The bridle (1) as claimed in claim 1, wherein the first fastener component (6) has a peg (9) onto which a hole (10) in a free end (23) of a strap (2) can be fitted.

5. The bridle (1) as claimed in claim 1, wherein a first fastener component (7) of the two fastener components (6, 7) is arranged so as to be longitudinally movable on one of the straps (2).

6. The bridle (1) as claimed in claim 5, wherein the second fastener component (7) is in the form of a sleeve through which at least one of the straps (2) can extend.

7. The bridle (1) as claimed in claim 1, wherein at least one of the two fastener components (6, 7) has a locking means (11, 12, 13, 14) in order to at least partially block a linear relative movement of the two fastener components (6, 7).

8. The bridle (1) as claimed in claim 7, wherein a first of the locking means (11, 12, 13, 14) is formed by a first recess (11) in an inner surface (15) of the second fastener components (7), wherein the recess (11) is designed and arranged such that a tip (16) of the peg (9) engages in the recess (11) in the closed state of the quick fastener (5).

9. The bridle (1) as claimed in claim 7,wherein a second of the locking means (11, 12, 13, 14) is formed by a second recess (12) in an outer surface (17) of the first fastener component (6).

10. The bridle (1) as claimed in claim 9, wherein a third of the locking means (11, 12, 13, 14) is formed by a protrusion (13) on an inner surface (18) of the second fastener component (7), wherein the protrusion (13) is de-signed and arranged such that it engages in the second recess (12) in the closed state of the quick fastener (5).

11. The bridle (1) as claimed claim 7, wherein a fourth of the locking means (11, 12, 13, 14) is formed by a latching shoulder (14) on the first fastener component (6), wherein the latching shoulder (14) is designed and arranged such that it blocks a further linear movement of the second fastener component (7) in a closing direction (26) in the closed state of the quick fastener (5).

12. A quick fastener (5) for a bridle (1) for riding horses, wherein the quick fastener (5) has two fastener components (6, 7) which are movable linearly with respect to one another in order to mechanically secure and release the quick fastener (5).

13. A method for replacing a bit (4) on a bridle (1) for riding horses, comprising at least the following steps:
a) releasing at least one quick fastener (5), to which end two fastener components (6, 7) of the quick fastener (5) are moved linearly with respect to one another in order to free a loop (8) formed by an end region of a strap (2) of the bridle (1),
b) connecting a bit (4) to the bridle (1) by closing the loop (8),
c) securing the quick fastener (5), to which end the two fastener components (6, 7) are moved linearly with respect to one another in order to secure the loop (8).

14. The method as claimed in claim 13, wherein the bit (4) is replaced on a bridle (1) having a head harness (3) formed by a plurality of straps (2), having the bit (4) releasably connected to the head harness (3), and having the at least one quick fastener (5) for connecting the strap (2) to a further component (2′, 4, 20) of the bridle (1), wherein the quick fastener (5) has the two fastener components (6, 7) which are movable linearly with respect to one another in order to mechanically secure and release the quick fastener (5).

15. The use of at least one quick fastener (5) for fastening a bit (4) to a bridle (1) for riding horses, wherein the quick fastener (5) has two fastener components (6, 7) which are movable linearly with respect to one another in order to mechanically secure and release the quick fastener (5).

16. A quick fastener (5) for releasably connecting a strap (2) to a further component (2′, 4, 20), wherein the quick fastener (5) has two fastener components (6, 7) which are movable linearly with respect to one another in order to mechanically secure and release the quick fastener (5).

17. A quick fastener (5) for releasably connecting a strap (2) to a further component (2′, 4, 20), wherein the quick fastener (5) has two fastener components (6, 7) which are movable linearly with respect to one another in order to mechanically secure and release the quick fastener (5), wherein the first fastener component (6) has a peg (9) onto which a hole (10) in a free end (23) of a strap (2) can be fitted, wherein at least one of the two fastener components (6, 7) has a locking means (11, 12, 13, 14) in order to at least partially block a linear relative movement of the two fastener components (6, 7), wherein a first of the locking means (11, 12, 13, 14) is formed by a first recess (11) in an inner surface (15) of the second fastener compo-nents (7), wherein the recess (11) is designed and arranged such that a tip (16) of the peg (9) engages in the recess (11) in the closed state of the quick fastener (5).
